(19) United States
(12) Patent Application Publication
(10) Pub. No.: US 2021/0130132 A1
(43) Pub. Date: May 6, 2021

(54) MULTICAR ELEVATOR SYSTEM AND A METHOD THERETO

(71) Applicant: KONE CORPORATION, HELSINKI (FI)

(72) Inventors: Marja-Liisa SIIKONEN, HELSINKI (FI); Janne SORSA, HELSINKI (FI)

(73) Assignee: KONE CORPORATION, HELSINKI (FI)

(21) Appl. No.: 17/149,265

(22) Filed: Jan. 14, 2021

Related U.S. Application Data
(63) Continuation of application No. PCT/FI2018/050572, filed on Aug. 2, 2018.

(51) Int. Cl. B66B 9/00; B66B 5/00; B66B 1/24

(52) U.S. Cl. CPC B66B 9/003; B66B 5/0087; B66B 2201/307; B66B 1/2491; B66B 1/2466

(57) ABSTRACT

A multicar elevator system includes a plurality of elevator sub-systems, each elevator sub-system including a shaft forming a loop path including a first vertical section and a second vertical section connected to each other with at least two horizontal sections. The first vertical section in each elevator sub-system is travelable upwards by at least one elevator car and the second vertical section is travelable downwards by at least one elevator car. The elevator system further include a reservation shaft accessible for at least one elevator car from each elevator subsystem. A method for controlling the multicar elevator system is disclosed.

### TECHNICAL FIELD

The invention concerns in general the technical field of elevators. More particularly, the invention concerns a control of an elevator system.

### BACKGROUND

One known elevator type is so called multicar elevator system in which a plurality of elevator cars travels in the same elevator shaft. The multicar elevator system may, in principle, be implemented in two different ways. A first implementation is such that multiple elevator cars travel upwards in one shaft and downwards in another shaft and the shafts are connected to each other with transfer channels through which the elevator cars move between the shafts. A second implementation of the multicar elevator system is so called multi-deck elevator system in which a plurality of cars is attached to each other and the cars travel in the same shaft upwards and downwards.

A traditional way to establish the first implementation is a so-called paternoster type elevator system in which elevator cars are arranged in chain and the move slowly along a circular path so that the elevator cars do not stop at floors, but the passengers jump in and out in motion. However, this kind of arrangement has challenges in safety, and the modern multicar elevator systems in which the elevator cars travel in the circular path allow independent motion of the elevator cars within the shafts. The modern multicar elevator systems are based on a solution in which the elevator car carries at least part of the elevator motor, such as a linear motor, generating power for moving the elevator car in the shaft. A simplified illustration of the modern multicar elevator system 110 is depicted in FIG. 1. The multicar elevator system comprises a first shaft A and a second shaft B. The individually movable elevator cars 115, 120 are arranged to travel in the shafts so that they may travel upwards in the shaft B and downwards in the shaft A. The operation of the multicar elevator system 110 may be controlled, at least in part, by a elevator controller 130, which may, in response to receipt of elevator calls from elevator call devices 140 to select an optimal elevator car 115, 120 for serving the elevator call and generate a control signal to the selected elevator car 115, 120 for instructing the elevator car 115, 120 to take care of the elevator call. Naturally, the elevator controller 130 may have other tasks for controlling the operation of the multicar elevator system 110.

However, the multicar elevator system in which the elevator cars travel along a circular path in two shafts connected to each other has several drawbacks. This is because the elevator cars cannot bypass each other even though they can travel independently to each other and this may cause delay in service time of passengers. Due to this the multicar elevator system is vulnerable to malfunction, such as one independently moving elevator car gets broken somewhere in the shaft which blocks a utilization of the elevator system as a whole. Hence, there is need to develop solutions which mitigate, at least in part, the vulnerability of the multicar elevator system in which the elevator cars are arranged to travel a circular path.

### SUMMARY

The following presents a simplified summary in order to provide basic understanding of some aspects of various invention embodiments. The summary is not an extensive overview of the invention. It is neither intended to identify key or critical elements of the invention nor to delineate the scope of the invention. The following summary merely presents some concepts of the invention in a simplified form as a prelude to a more detailed description of exemplifying embodiments of the invention.

An objective of the invention is to present a multicar elevator system and a method for controlling of a multicar elevator system.

The objectives of the invention are reached by a multicar elevator system and a method as defined by the respective independent claims.

According to a first aspect, a multicar elevator system is provided the multicar elevator system comprising: a plurality of elevator sub-systems, each elevator sub-system comprising a shaft forming a loop path comprising a first vertical section and a second vertical section connected to each other with at least two horizontal sections, wherein the first vertical section in each elevator subsystem is travelable upwards by at least one elevator car and the second vertical section is travelable downwards by at least one elevator car; the elevator system further comprising a reservation shaft accessible for at least one elevator car from each elevator sub-system.

Moreover, the multicar elevator system may further comprise at least one controller configured to control at least one entity in at least one elevator subsystem the plurality of the elevator sub-systems. The at least one controller may be configured to: monitor an operation of the multicar elevator subsystem; and in response to detection of a predetermined condition in at least one of the elevator sub-systems generate a control signal for enabling a use of the reservation shaft by the at least one elevator car. The predetermined condition may be at least one of the following: a malfunction of at least one elevator car, utilization rate of at least one elevator sub-system.

Still further, the controller, such as a group controller, may be configured to communicate an availability of the reservation shaft to the at least one elevator car. The controller may be configured to include an indication in a communication of the availability of the reservation shaft to at least one elevator car, the indication defining a direction into which the reservation shaft is travelable.

The reservation shaft may be arranged at least along one vertical section of the shaft of each plurality of elevator subsystems wherein the reservation shaft is accessible for at least one elevator car from each elevator sub-system.

According to a second aspect, a method for controlling of a multicar elevator system is provided, the multicar elevator system comprising: a plurality of elevator sub-systems, each elevator sub-system comprising a shaft forming a loop path comprising a first vertical section and a second vertical section connected to each other with at least two horizontal sections, wherein the first vertical section in each elevator sub-system is travelable upwards by at least one elevator car and the second vertical section is travelable downwards by at least one elevator car; the method comprising: detecting a predetermined condition in at least one of the elevator sub-systems; generating a control signal for enabling a use of a reservation shaft by the at least one elevator car, the reservation shaft accessible for at least one elevator car from each elevator sub-system.

The method may further comprise a step of communicating an availability of the reservation shaft to the at least one elevator car. Also an indication may be included in a communication of the availability of the reservation shaft to the at least one elevator car, the indication defining a direction into which the reservation shaft is travelable.

The expression “a number of” refers herein to any positive integer starting from one, e.g. to one, two, or three.

The expression “a plurality of” refers herein to any positive integer starting from two, e.g. to two, three, or four.

Various exemplifying and non-limiting embodiments of the invention both as to constructions and to methods of operation, together with additional objects and advantages thereof, will be best understood from the following description of specific exemplifying and non-limiting embodiments when read in connection with the accompanying drawings.

The verbs “to comprise” and “to include” are used in this document as open limitations that neither exclude nor require the existence of unrecited features. The features recited in dependent claims are mutually freely combinable unless otherwise explicitly stated. Furthermore, it is to be understood that the use of “a” or “an”, i.e. a singular form, throughout this document does not exclude a plurality.

### BRIEF DESCRIPTION OF FIGURES

The embodiments of the invention are illustrated by way of example, and not by way of limitation, in the figures of the accompanying drawings.

FIG. 1 illustrates schematically an example of a modern multicar elevator system according to prior art.

FIG. 2 illustrates schematically an example of a multicar elevator system according to an embodiment of the present invention.

FIGS. 3A-3C illustrate schematically examples of multicar elevator system layouts according to an embodiment of the invention.

FIG. 4 illustrates schematically a method according to an embodiment of the invention.

### DESCRIPTION OF THE EXEMPLIFYING EMBODIMENTS

The specific examples provided in the description given below should not be construed as limiting the scope and/or the applicability of the appended claims. Lists and groups of examples provided in the description given below are not exhaustive unless otherwise explicitly stated.

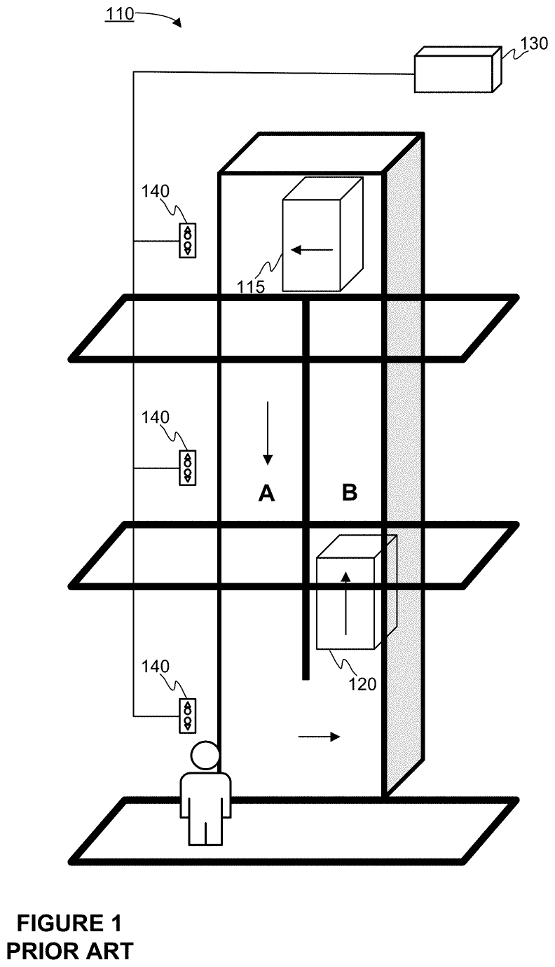

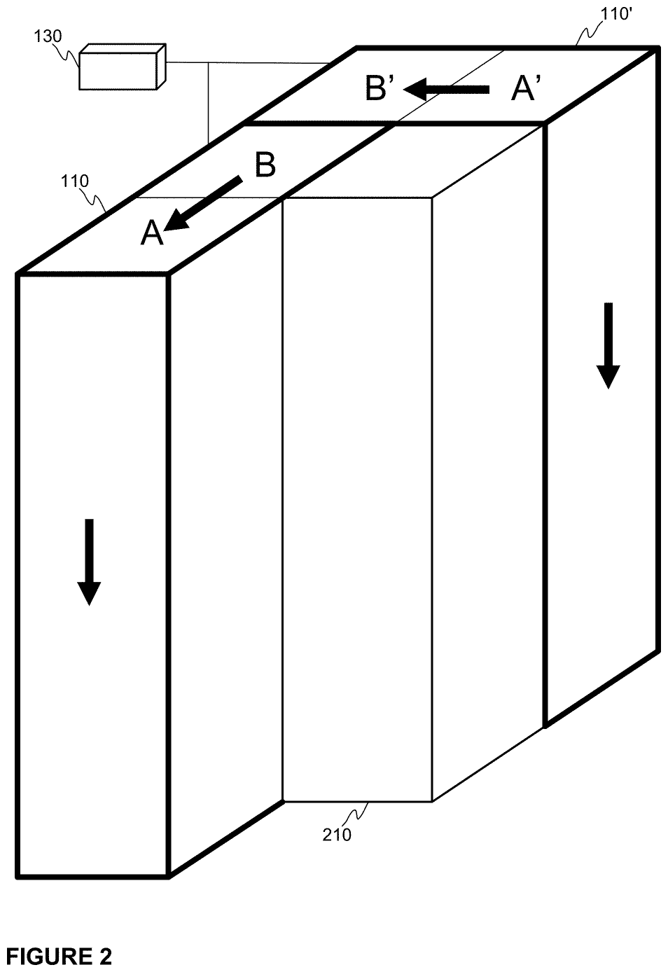

FIG. 2 illustrates schematically an example of a multicar elevator system according to the present invention. The multicar elevator system according to an embodiment of the invention comprises a plurality of elevator sub-systems as schematically illustrated in FIG. 1. In FIG. 2 the number of elevator subsystems is two referred with references 110 and 110′. Each elevator subsystem may be implemented so that it comprises two shafts A, B; A′, B′, i.e. vertical sections, in which at least one elevator car may travel in a loop path. The loop path refers to an implementation in which the elevator car may travel upwards in a first vertical section, such as in a first shaft B; B′, and downwards in a second vertical section, such as in a second shaft A, A′. The elevator car may be transferred between the first vertical section B, B′ and the second vertical section A, A′ through at least two horizontal sections, known also as transfer channels, arranged between the vertical sections. The horizontal sections, i.e. transfer channels, may e.g. be arranged at the upper section and at the lower section of the shafts, as schematically illustrated in FIG. 1. The power generation means for moving the elevator car 115, 120, 155, 160 in each subsystem may be any suitable means. For example, the linear motor may be used in the context of the present invention. However, the invention is not limited to that only, but any means which may be controlled with a control device for controlling the motion of the elevator car may be applied to. Moreover, even if it is illustrated two elevator sub-systems 110, 110′ in FIG. 2, the number of sub-systems is not anyhow limited in view of an inventive idea of the present idea.

FIG. 2 also illustrates schematically at least some aspects of a control system implementing controlling of the multicar elevator system at least in part in a non-limiting elevator environment. The multicar elevator system may comprise one or more control entities configured to control at least some operations of the multicar elevator system. In the implementation as illustrated in FIG. 2, the control entity is, as a non-limiting example, a device called a group controller 130 which may be configured to control an operation of the elevator system of FIG. 2 at least in part. The group controller 130 may be configured to receive input signals and generate output signals to predetermined entities. For example, passengers may indicate with an elevator call device that they need a service from the multicar elevator system. The elevator call devices may e.g. reside at floors from which the passengers may enter the elevator cars and exit from them. The call signals may be delivered to the group controller 130, which may be configured to perform operations for determining an elevator car, which serves the elevator call in question. In response to the determination of the elevator car the group controller 130 may be configured to generate output signals, such as control signals, for instructing one or more elevator cars to operate so that the elevator call is served. The control signal may e.g. refer to a signal carrying information for controlling power generation means of one or more elevator cars. The group controller 130 may also be configured to communicate with any external entities, such as with data centre configured to monitor and control of the elevator system and/or any sub-systems therein. The communication to and from the group controller 130 may be arranged in a wireless or in a wired manner so that the communication between the entities may be established as described.

According to the present invention the multicar elevator system further comprises a reservation shaft 210 into which one or more elevator cars may be instructed if a predetermined condition is fulfilled. The predetermined condition may e.g. refer to a situation in which it is detected that one or more elevator cars are not operating properly i.e. there is a malfunction in the one or more elevator cars. In response to a detection of the malfunction the group controller 130 may be configured to generate a control signal for enabling use of the reservation shaft 210 by at least one elevator car, such as the one having the malfunction. The generation of the control signal may refer to, but is not limited to, an implemented in which the control signal activates the reservation shaft 210 available for use. The activation may refer to powering on the reservation shaft 210. This may refer to an implementation the stator beam mounted in the shaft is provided with electricity for cooperating with a mover, such as a linear motor, arranged in the elevator cars. The activation may also refer to instructing one or more doors to open for accessing the reservation shaft 210 by the at least one elevator car. According to an embodiment the availability of the reservation shaft 210 for use through the activation may be communicated to one or more elevator cars by the group controller 130. The group controller 130 may be configured to utilize one or more communication channels implemented either in a wired manner or wirelessly or even in both ways between the group controller 130 and the one or more elevator cars.

In a further embodiment of the invention the group controller 130 may be configured to include an indication in the above mentioned, or a separate, communication of the availability of the reservation shaft to the at least one elevator car. The indication advantageously defines a direction into which the reservation shaft is travelable, such as from where the reservation shaft is to be accessed. In response to a receipt of the mentioned piece of information the elevator cars may compare the information in the indication to their current travel direction and perform decisions accordingly. This kind of operation may be applicable in a situation that one or more elevator cars are broken so that the block one vertical section in their normal loop path in one of the sub-systems. In such a situation the activation of the reservation shaft 210 may provide a path for at least one other elevator car to by-pass the broken elevator car blocking the vertical section, or possibly even a horizontal section, in the loop path. However, in an embodiment of the invention the reservation shaft is used for storing one or more elevator cars, such as the ones not operating properly, for allowing other elevator cars to travel in the elevator sub-systems in an optimal way. In this kind of embodiment the reservation shaft 210 may operate as a storage for certain elevator cars. In this kind of situation the direction from which the reservation shaft 210 is travelable is important to control in order to avoid collisions between the elevator cars instructed in the reservation shaft 210.

According to another embodiment the group controller 130 may be configured to detect the broken elevator car blocking at least one section in the loop path and perform an analysis for determining into which direction the elevator cars are traveling. In other words, it may be configured to determine the destination calls of each elevator car serving passengers and to determine a traffic situation at the instant of time. Based on the information the group controller 130 may, in accordance with predetermined service rules, to determine a direction to which the reservation shaft 210 shall be allocated for solving the existing traffic situation optimally. The group controller 130 may be configured to perform the analysis continuously and in that manner control one or more elevator cars to travel at a certain instant of time through the reservation path, whereas the group controller 130 may be configured to re-evaluate dynamically, e.g. by taking into account pending destination calls, a direction for which the reservation shaft 210 shall be allocated. The dynamic allocation is important due to a fact that the reservation shaft 210 may be allowed for use by all the subsystems, i.e. 110 and 110′ in the embodiment of FIG. 2. In case the reservation shaft 210 is used for a storage to one or more elevator cars the group controller may be configured to generate control signals to elevator cars to access the reservation shaft 210 or even to leave the reservation shaft 210.

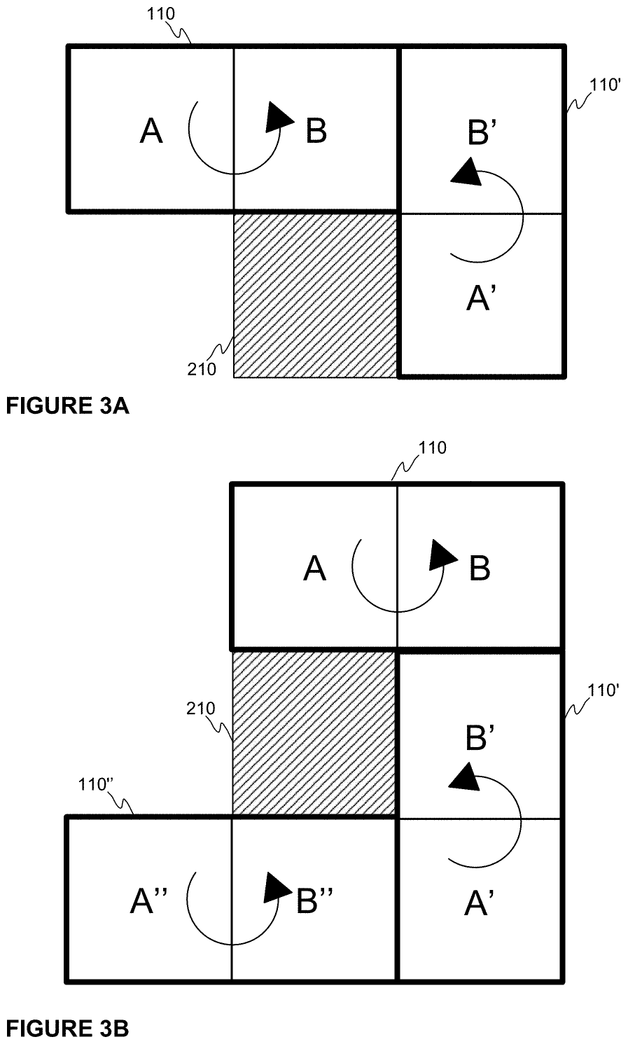

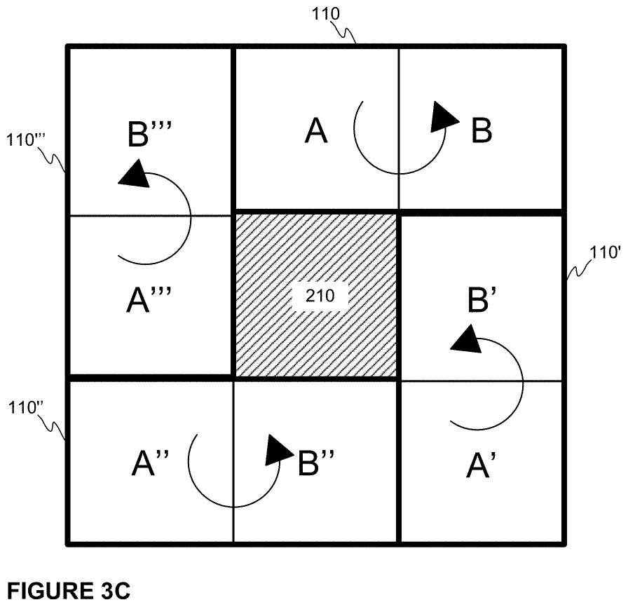

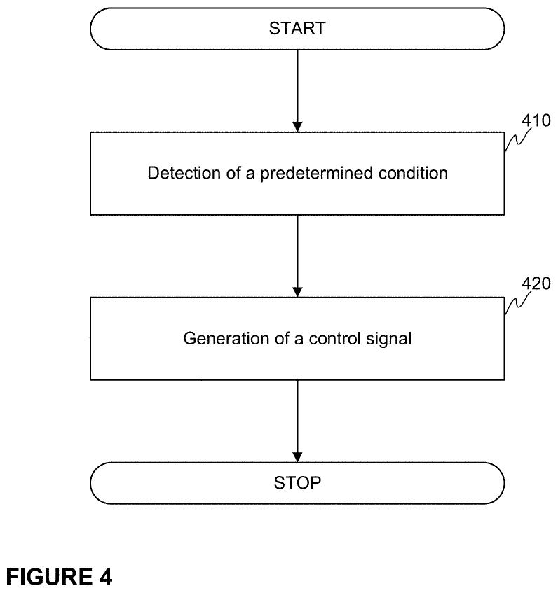

A further predetermined condition for enabling the use of the reservation shaft may be based on a monitoring of utilization rate of at least one sub-system. In other words, it may be determined if the multicar elevator system may serve the service requests, i.e. the elevator calls, at a predefined service level, and in response to a detection that the service level is below a predetermined reference value, the group controller 130 may be configured to activate the reservation shaft for use in order to provide the elevator cars of the sub-system a further path to move in the multicar elevator system. In this manner it is possible to improve the service level. Moreover, the utilization rate of the at least one sub-system, and hence the whole elevator system, such as the one schematically illustrated in FIG. 2 or any of FIGS. 3A-3C as non-limiting examples, may be controlled by returning one or more elevator cars stored in the reservation shaft 210 into use in an elevator sub-system. The sub-system into which the elevator car in question is returned may be the same from which it was instructed to the reservation shaft 210 or any other into which there is access.

FIGS. 3A-3C illustrate schematically some non-limiting examples of advantageous layouts for establishing the reservation shaft 210 in a multicar elevator system comprising at least two sub-systems, each of the at least two subsystems having a first shaft A, A′ for a traffic to a first direction and a second shaft B, B′ for a traffic to an opposite direction to the traffic in the first shaft A, A′. The first shaft and the second shaft are connected to each other with at least two transfer channels for establishing a loop path in order to enable a circular motion of a number of elevator cars in the sub-systems. The sub-systems comprise further devices for enabling the motion of the elevator cars in the sub-systems. The further devices may refer to, but is not only limited to, at least some motion generation means, such as a stator beam, which in cooperation with motion generation means arranged in the elevator car, such as a linear motor, generates a force for moving the elevator car in the loop path. Bearing the above in mind one aspect to be taken into account with the layouts is a need to optimize space needed for the elevator system.

FIG. 3A illustrates schematically a layout corresponding to the example of the multicar elevator system as schematically illustrated in FIG. 2. The multicar elevator system of FIG. 3A comprises two sub-systems implemented so that the shafts B and B′ from the different sub-systems 110, 110′ are next to each other so that the sub-systems together form a L-shaped structure wherein the reservation shaft 210 may be established in a corner of the two subsystems 110, 110′. As a result, the reservation shaft 210 may be accessed from the shaft B of the first sub-system 110 and from the shaft A′ of the second sub-system 110′.

FIG. 3B illustrates schematically another non-limiting layout in a context of a multicar elevator system comprising three sub-systems 110, 110′ and 110″, each of the sub-system 110, 110′, 110″ being the type as described. The multicar elevator system of FIG. 3B is implemented so that the sub-systems 110, 110′, 110″ are arranged in U-shaped chain so that the reservation shaft 210 may be established in a middle of the U-shaped chain. As a result the reservation shaft 210 is accessible from all the sub-systems 110, 110′, 110″ so that the shaft A of the first sub-system 110, the shaft B′ of the second sub-system 110′ and shaft B″ of the third sub-system 110″ provides access to the reservation shaft 210 for the elevator cars.

FIG. 3C, in turn, illustrates schematically a further non-limiting layout in a context of a multicar elevator system comprising four sub-systems 110, 110′, 110″ and 110′″, each of the sub-system 110, 110′, 110″, 110′″ being the type as described. The multicar elevator system of FIG. 3B is implemented so that the sub-systems 110, 110′, 110″, 110′″ are arranged in quadrangle shape so that the reservation shaft 210 may be established in a middle of the quadrangle shape. As a result the reservation shaft 210 is accessible from all the sub-systems 110, 110′, 110″, 110′″ so that the shaft A of the first sub-system 110, the shaft B′ of the second sub-system 110′, shaft B″ of the third subsystem 110″ and the shaft A′″ of the fourth sub-system 110′″ provides access to the reservation shaft 210 for the elevator cars.

The accessibility to the reservation shaft 210 in the layouts as schematically depicted in FIGS. 3A-3C, and in any other possible layouts, may be controlled by the group controller 130 in the manner as described. The controlling may comprise among the tasks as described instructing doors and/or similar access channels to open or close accordingly in order to establish the path between one or more shafts of a sub-system and the reservation shaft 210. Furthermore, the controlling may comprise setting of motion devices belonging to the mentioned entities so that they form an access between one or more shafts of a sub-system and the reservation shaft 210. As may be seen from the exemplifying figures and the description herein that the reservation shaft 210 may be arranged so that it travels along the shafts of elevator sub-systems, especially at least along at least one vertical section of each shaft of an elevator sub-system in question. This allows the accessibility to the reservation shaft 210 from one or more positions of the shafts of the elevator sub-systems into which an access, such as a door or an opening, is arranged.

Some aspects of the invention relate to a method for controlling a multicar elevator system, such as a capacity of the multicar elevator system. The multicar elevator system may comprise a plurality of elevator sub-systems 110, 110′, 110″, 110′″, each elevator sub-system 110, 110′, 110″, 110′″ comprising a shaft forming a loop path comprising a first vertical section and a second vertical section connected to each other with at least two horizontal sections, wherein the first vertical section in each elevator sub-system 110, 110′, 110″, 110′″ is travelable upwards by at least one elevator car and the second vertical section is travelable downwards by at least one elevator car. The method may be arranged so that first it is detected a predetermined condition in at least one of the elevator sub-systems 110, 110′, 110″, 110′″ and in response to the detection a control signal is generated for enabling a use of a reservation shaft 210 by the at least one elevator car wherein the reservation shaft 210 is accessible for at least one elevator car from each elevator sub-system 110, 110′, 110″, 110′″. The method may further comprise a step of communicating an availability of the reservation shaft 210 to the at least one elevator car. An indication defining a direction into which the reservation shaft 210 is travelable may be included in a communication of the availability of the reservation shaft 210 to the at least one elevator car. The method as described may be implemented by a controller implementing a control function in the multicar elevator system.

The description of at least some aspects of the invention above is done in an environment wherein a multicar elevator system as described is controlled with a single control entity i.e. the group controller 130. However, the present invention is not limited only to such an implementation, but the control function may be arranged in a plurality of ways. In some embodiment the multicar elevator system comprises a plurality of controllers, such as at least one for each subsystem, configured to communicate other entities in the sub-system and with each other. In such a manner the functionalities of the group controller may be divided to multiple controllers. In a still further embodiment the multicar elevator system may be implemented in such a manner that a controller is arranged in the elevator cars traveling in the system for performing a control function. For example, it may be arranged that the elevator cars comprise the controller on their own which are configured to communicate with each other and with other entities, such as with necessary elements of the reservation shaft. In other words, an elevator car may monitor at least its own operation, but also an operation of other elevator cars through communication and in any other manner, and in response to a detection of a predetermined condition during the monitoring, the controller of at least one elevator car may generate a control signal enabling a use of the reservation shaft by at least one elevator car. In this kind of implementation the control function is shared with a plurality of controller entities arranged in the elevator cars. In a still further embodiment the control function may be implemented in a cloud computing manner. In other words, the functionality of the controller is implemented into a network of remote servers communicatively coupled to each other but also to the multicar elevator system. Naturally, the controller may be implemented in a combined manner by using a plurality of arrangements described above. In any of the implementation of the control function the at least one controller may be configured to control at least one entity in at least one of the elevator sub-systems, such as an elevator car and/or control device of the reservation shaft, for enabling the functionality according to the invention. For example, the controller may be configured to monitor an operation of the multicar elevator sub-system, and any entities therein, and in response to detection of a predetermined condition in at least one of the elevator sub-systems to generate a control signal for enabling a use of the reservation shaft 210 by the at least one elevator car. Also the controller in question may be configured to include an indication of the availability of the reservation shaft 210 to at least one elevator car wherein the indication may defined a direction into which the reservation shaft 210 is trayeleable.

The specific examples provided in the description given above should not be construed as limiting the applicability and/or the interpretation of the appended claims. Lists and groups of examples provided in the description given above are not exhaustive unless otherwise explicitly stated.

1. A multicar elevator system comprising:
a plurality of elevator sub-systems, each elevator sub-system comprising a shaft forming a loop path comprising a first vertical section and a second vertical section connected to each other with at least two horizontal sections, wherein the first vertical section in each elevator sub-system is travelable upwards by at least one elevator car and the second vertical section is travelable downwards by at least one elevator car; and
a reservation shaft accessible for at least one elevator car from each elevator subsystem.

2. The multicar elevator system of claim 1, the multicar elevator system further comprising:
at least one controller configured to control at least one entity in at least one elevator sub-system.

3. The multicar elevator system of claim 2, wherein the at least one controller is configured to:
monitor an operation of the multicar elevator sub-system; and
in response to detection of a predetermined condition in at least one of the elevator subsystems, generate a control signal for enabling a use of the reservation shaft by the at least one elevator car.

4. The multicar elevator system of claim 3, wherein the predetermined condition is at least one of the following: a malfunction of at least one elevator car, and utilization rate of at least one elevator sub-system.

5. The multicar elevator system of claim 3, wherein the controller is configured to communicate an availability of the reservation shaft to the at least one elevator car.

6. The multicar elevator system of claim 5, wherein the controller is configured to include an indication in a communication of the availability of the reservation shaft to the at least one elevator car, the indication defining a direction into which the reservation shaft is travelable.

7. The multicar elevator system of claim 1, wherein the reservation shaft is arranged at least along one vertical section of the shaft of each of the plurality of elevator subsystems, wherein the reservation shaft is accessible for at least one elevator car from each elevator sub-system.

8. A method for controlling of a multicar elevator system, the multicar elevator system comprising:
a plurality of elevator sub-systems, each elevator sub-system comprising a shaft forming a loop path comprising a first vertical section and a second vertical section connected to each other with at least two horizontal sections, wherein the first vertical section in each elevator sub-system is travelable upwards by at least one elevator car and the second vertical section is travelable downwards by at least one elevator car,
the method comprising:
detecting a predetermined condition in at least one of the elevator sub-systems; and
generating a control signal for enabling a use of a reservation shaft by the at least one elevator car, the reservation shaft being accessible for at least one elevator car from each elevator sub-system.

9. The method of claim 8, further comprising a step of communicating an availability of the reservation shaft to the at least one elevator car.

10. The method of claim 9, wherein an indication is included in a communication of the availability of the reservation shaft to the at least one elevator car, the indication defining a direction into which the reservation shaft is travelable.

11. The multicar elevator system of claim 4, wherein the controller is configured to communicate an availability of the reservation shaft to the at least one elevator car.

12. The multicar elevator system of claim 2, wherein the reservation shaft is arranged at least along one vertical section of the shaft of each of the plurality of elevator subsystems, wherein the reservation shaft is accessible for at least one elevator car from each elevator sub-system.

13. The multicar elevator system of claim 3, wherein the reservation shaft is arranged at least along one vertical section of the shaft of each of the plurality of elevator subsystems, wherein the reservation shaft is accessible for at least one elevator car from each elevator sub-system.

14. The multicar elevator system of claim 4, wherein the reservation shaft is arranged at least along one vertical section of the shaft of each of the plurality of elevator subsystems, wherein the reservation shaft is accessible for at least one elevator car from each elevator sub-system.

15. The multicar elevator system of claim 5, wherein the reservation shaft is arranged at least along one vertical section of the shaft of each of the plurality of elevator subsystems, wherein the reservation shaft is accessible for at least one elevator car from each elevator sub-system.

16. The multicar elevator system of claim 6, wherein the reservation shaft is arranged at least along one vertical section of the shaft of each of the plurality of elevator subsystems, wherein the reservation shaft is accessible for at least one elevator car from each elevator sub-system.
